(19) United States
(12) Patent Application Publication
(10) Pub. No.: US 2025/0060770 A1
(43) Pub. Date: Feb. 20, 2025

(54) LINEAR REGULATOR, SEMICONDUCTOR DEVICE, AND SWITCHING POWER SUPPLY

(71) Applicant: ROHM CO., LTD., Kyoto (JP)

(72) Inventor: Kenichi OKAJIMA, Kyoto (JP)

(21) Appl. No.: 18/937,282

(22) Filed: Nov. 5, 2024

Related U.S. Application Data
(63) Continuation of application No. PCT/JP2023/012464, filed on Mar. 28, 2023.

(30) Foreign Application Priority Data
May 24, 2022 (JP) 2022-084737

(51) Int. Cl. G05F 1/575; H02M 3/158

(52) U.S. Cl. CPC G05F 1/575; H02M 3/158

(57) ABSTRACT

A linear regulator includes: a first transistor of an N-channel type configured to be connected between an application terminal for an input terminal and an application terminal for a stabilized voltage; a second transistor of an N-channel type configure to, by forming a current mirror type output stage with the first transistor, generate an output current flowing in the first transistor by mirroring a bias current flowing in the second transistor itself; a feedback controller circuit configured to control the bias current according to the difference between a feedback voltage corresponding to the stabilized voltage and a predetermined reference voltage; and a load configured to draw a first leakage current from a control terminal common to the first and second transistors.

### CROSS-REFERENCE TO RELATED APPLICATIONS

This nonprovisional application is a continuation application of International Patent Application No. PCT/JP2023/012464 filed on Mar. 28, 2023, which claims priority to Japanese Patent Application No. 2022-084737 filed on May 24, 2022, the entire contents of which are hereby incorporated by reference.

### TECHNICAL FIELD

The present disclosure relates to linear regulators, semiconductor devices, and switching power supplies.

### BACKGROUND ART

Linear regulators are used as a means of power supply for a variety of devices.

An example of a conventional technology related to the above can be seen in Patent Document 1 identified below.

### CITATION LIST

### Patent Literature

Patent Document 1: JP-A-2020-071710

### BRIEF DESCRIPTION OF DRAWINGS

FIG. 1 is a diagram showing the overall configuration of a switching power supply.

FIG. 2 is a diagram showing a schematic configuration of a linear regulator.

FIG. 3 is a diagram showing a linear regulator according to a first embodiment (comparative example).

FIG. 4 is a diagram showing a linear regulator according to a second embodiment.

FIG. 5 is a diagram showing the temperature characteristics of a source voltage and a gate voltage.

FIG. 6 is a diagram showing the temperature characteristics of a circuit current.

### DESCRIPTION OF EMBODIMENTS

### <Switching Power Supply>

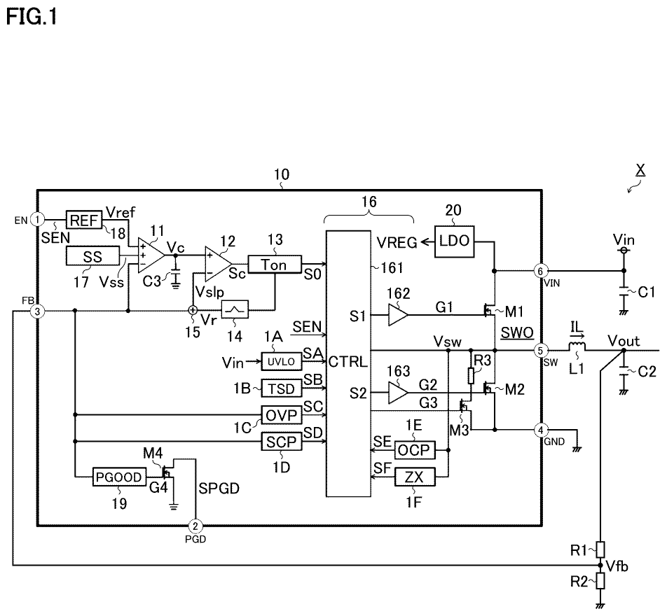

FIG. 1 is a diagram showing an overall configuration of a switching power supply. The switching power supply X of this configuration example is a buck DC/DC converter that generates a desired output voltage Vout by bucking an input voltage Vin. As shown in the diagram, the switching power supply X includes a semiconductor device 10 and various discrete components (capacitors C1 and C2, an inductor L1, and resistors R1 and R2) that are externally connected to it.

The semiconductor device 10 is the principal agent that comprehensively controls the operation of the switching power supply X (i.e., what is generally called a power supply control IC (integrated circuit)). The semiconductor device 10 has a plurality of external terminals (pin-1 to pin-6 in the diagram) to establish electrical connection with the outside of the device.

Pin-1 is an enable input terminal EN, pin-2 is a power-good output terminal PGD, pin-3 is a feedback input terminal FB, pin-4 is a ground terminal GND, pin-5 is a switching output terminal SW, and pin-6 is a power supply terminal VIN to which the input voltage Vin is applied.

Next, the connections outside the semiconductor device 10 will be described. The first terminal of the capacitor C1 is connected to the power supply terminal VIN. The second terminal of the capacitor C1 is connected to a ground terminal. The first terminal of the inductor L1 is connected to the switching output terminal SW. The second terminal of the inductor L1 and the first terminals of the resistor R1 and the capacitor C2 are all connected to an application terminal for the output voltage Vout. The second terminal of the resistor R1 and the first terminal of the resistor R2 are both connected to the feedback input terminal FB (i.e., an application terminal for a feedback voltage Vfb). The second terminals of the capacitor C2 and the resistor R2 are both connected to the ground terminal.

The inductor L1 and the capacitor C2 function as an LC filter that rectifies and smooths a switching voltage Vsw with a rectangular waveform to generate the output voltage Vout.

The resistors R1 and R2 function as a feedback voltage generation circuit (voltage division circuit) that outputs, from the connection node between them, a feedback voltage Vfb corresponding to the output voltage Vout (i.e., a division voltage of the output voltage Vout). Though not specifically shown in the diagram, a speed-up capacitor can be connected between the terminals of the resistor R1 in parallel with it for smooth start-up of the switching power supply X. When the output voltage Vout falls within the input dynamic range of the semiconductor device 10, the resistors R1 and R2 can be omitted and the output voltage Vout can be fed directly to the feedback input terminal FB.

### <Semiconductor Device>

With reference still to FIG. 1, the internal configuration of the semiconductor device 10 will be described in detail below. The semiconductor device 10 of this configuration example includes, integrated in it, an error amplifier 11, a comparator 12, an on-time setting circuit 13, a ripple generation circuit 14, an adder circuit 15, a drive control circuit 16, a soft-start circuit 17, a reference voltage generation circuit 18, a power-good detection circuit 19, a low-input protection circuit 1A, an overheat protection circuit 1B, an overvoltage protection circuit 1C, a short-circuit protection circuit 1D, an overcurrent protection circuit 1E, a zero-crossing detection circuit 1F, a linear regulator 20, a capacitor C3, an output element M1, a synchronous-rectification element M2, transistors M3 and M4, and a resistor R3.

The error amplifier 11 generates an error voltage Vc according to the difference between the lower of a reference voltage Vref and a soft-start voltage Vss, which are fed to its two non-inverting input terminals (+) respectively, and the feedback voltage Vfb, which is fed to its inverting input terminal (−). The error voltage Vc rises when the feedback voltage Vfb is lower than the lower of the reference voltage Vref and the soft-start voltage Vss, and falls when the feedback voltage Vfb is higher than the lower of the reference voltage Vref and the soft-start voltage Vss.

The comparator 12 generates a comparison signal Sc by comparing a slope voltage Vslp, which is fed to its inverting input terminal (−), with the error voltage Vc, which is fed to its non-inverting input terminal (+). The comparison signal Sc is at high level when the slope voltage Vslp is lower than the error voltage Vc, and is at low level when the slope voltage Vslp is higher than the error voltage Vc. The comparator 12 can have hysteresis characteristics.

The on-time setting circuit 13 generates a switching control signal S0 so as to keep the output element M1 on for an on-time Ton after the comparison signal Sc rises to high level.

The ripple generation circuit 14 generates a ripple voltage Vr which simulates the ripple component of the output voltage Vout in synchronization with the switching control signal S0.

The adder circuit 15 generates the slope voltage Vslp by adding up the feedback voltage Vfb and the ripple voltage Vr.

The drive control circuit 16 includes as its components a controller 161 and drivers 162 and 163.

As basic output feedback control, the controller 161 generates gate control signals S1 and S2 so as to keep the output voltage Vout equal to the desired target value by a bottom-detection fixed-on-time method according to the switching control signal S0.

The controller 161 has a function to forcibly stop the switching driving of each of the output element M1 and the synchronous rectifier element M2 according to a low-input protection signal SA, an overheat protection signal SB, an overvoltage protection signal SC, a short-circuit protection signal SD and an overcurrent protection signal SE.

The controller 161 also has a function to stop the switching driving of each of the output element M1 and the synchronous rectifier element M2 under a light load according to a zero-crossing detection signal SF. For example, when with the output element M1 off and the synchronous rectifier element M2 on the zero-crossing detection signal SF rises to at high level, that is, when the switching voltage Vsw is detected to be higher than the zero-crossing detection value (e.g., GND), the controller 161 can turn off the synchronizes rectifier M2.

The controller 161 further has a function to generate a gate drive signal G3 for the transistor M3 according to an enable signal SEN which is externally fed to the enable input terminal EN.

The driver 162 drives the output element M1 by generating a gate drive signal G1 according to the gate control signal S1. For example, the gate drive signal G1 is at high level when the gate control signal S1 is at high level, and is at low level when the gate control signal S1 is at low level.

The driver 163 drives the synchronous rectifier element M2 by generating a gate drive signal G2 according to the gate control signal S2. For example, the gate drive signal G2 is at high level when the gate control signal S2 is at high level, and is at low level when the gate control signal S2 is at low level.

The soft-start circuit 17 generates a soft-start voltage Vss, which rises gently after the semiconductor device 10 starts up.

The reference voltage generation circuit 18 generates a predetermined reference voltage Vref (i.e., the target value of the feedback voltage Vfb, which hence corresponds to the target value of the output voltage Vout). The reference voltage generation circuit 18 is enabled and disabled according to the enable signal SEN externally fed to the enable input terminal EN.

The power-good detection circuit 19 detects whether the feedback voltage Vfb is higher than a predetermined power-good detection threshold value and generates a gate drive signal G4.

The low-input protection circuit 1A (what is generally called a UVLO (undervoltage lockout) circuit) detects whether the input voltage Vin is higher than a predetermined low-input protection threshold value and generates the low-input protection signal SA.

The overheat protection circuit 1B detects whether the junction temperature Tj of the semiconductor device 10 (in particular, the output element M1) is higher than a predetermined overheat protection threshold value and generates the overheat protection signal SB.

The overvoltage protection circuit 1C detects whether the feedback voltage Vfb is higher than a predetermined overvoltage protection threshold value and generates the overvoltage protection signal SC.

The short-circuit protection circuit 1D monitors the feedback voltage Vfb and generates the short-circuit protection signal SD.

The overcurrent protection circuit 1E monitors the switching voltage Vsw and generates the overcurrent protection signal SE.

The zero-crossing detection circuit 1F detects the zero-crossing (flow reversal) of the inductor current IL passing through the synchronous rectifier element M2 by monitoring the terminal-to-terminal voltage across the synchronous rectifier element M2 (corresponding to the switching voltage Vsw) when the output element M1 is off and the synchronous rectifier element M2 is on.

The capacitor C3 is connected between the output terminal of the error amplifier 11 and the ground terminal for phase compensation to prevent oscillation of the error amplifier 11.

The output element M1 (e.g., an NMOSFET (N-channel metal-oxide-semiconductor field-effect transistor)) functions as an upper switch in a switching output stage SWO that generates the switching voltage Vsw from the input voltage Vin. The drain of the output element M1 is connected to the power supply terminal VIN. The source of the output element M1 is connected to the switching output terminal SW. The gate of the output element M1 is connected to an application terminal for the gate drive signal G1. The output element M1 is on when the gate drive signal G1 is at high level, and is off when the gate drive signal G1 is at low level.

The synchronous rectifier element M2 (e.g., an NMOSFET) functions as a lower switch in the switching output stage SWO. The drain of the synchronous rectifier element M2 is connected to the switching output terminal SW. The source of the synchronous rectifier element M2 is connected to the ground terminal GND. The gate of the synchronous rectifier element M2 is connected to an application terminal for the gate drive signal G2. The synchronous rectifier element M2 is on when the gate drive signal G2 is at high level, and is off when the gate drive signal G2 is at low level.

As the rectifier element, instead of the synchronous rectifier element M2, a rectifier diode (e.g., Schottky barrier diode) can be used of which the cathode is connected to the switching output terminal SW and of which the anode is connected to the ground terminal GND.

The output element M1 and the synchronous rectifier element M2 can be externally connected to the semiconductor device 10. This necessitates, instead of the switching output terminal SW, an external input terminal for the switching voltage Vsw and external output terminals for the gate drive signals G1 and G2.

When a high voltage may be applied to the switching output stage SWO, high-withstand-voltage devices such as IGBTs (insulated gate bipolar transistors), SiC devices or GaN devices can be used as the output element M1 and the synchronous rectifier element M2.

The switching output stage SWO generates a switching voltage Vsw with a rectangular waveform that is pulse-driven between the input voltage Vin and the ground voltage PGND by complementarily turning on and off the output element M1 and the synchronous rectifier element M2 connected to form a half-bridge.

In the present description, the term “complementarily” is used to cover not only operation in which the on/off states of the output element M1 and the synchronous rectifier element M2 are completely reversed but also operation in which delays are given to their on/off transition timing (i.e., operation in which a simultaneously-off period is provided).

The first terminal of the resistor R3 is connected to the switching output terminal SW. The second terminal of the resistor R3 is connected to the drain of the transistor M3. The source of the transistor M3 is connected to the ground terminal GND. The gate of the transistor M3 is connected to an application terminal for the gate drive signal G3. The transistor M3 is on when the gate drive signal G3 is at high level, and is off when the gate drive signal G3 is at low level. So connected, the resistor R3 and the transistor M3 function as a pull-down circuit to keep the switching output terminal SW at the same potential as the ground terminal GND when the enable signal SEN is at the logic level corresponding to the disabled state.

A transistor M4 functions as an open-drain output stage. The drain of the transistor M4 is connected to the power-good output terminal PGD (i.e., an application terminal for a power-good signal SPGD). The source of the transistor M4 is connected to the ground terminal. The gate of the transistor M4 is connected to an application terminal for the gate drive signal G4. The transistor M4 is on when the gate drive signal G4 is at high level, and is off when the gate drive signal G4 is at low level.

The linear regulator 20 generates a stabilized voltage VREG by bucking the input voltage Vin. For example, an LDO (low dropout) regulator can be suitably used as the linear regulator 20. For example, the stabilized voltage VREG is used as an internal supply voltage for the semiconductor device 10.

### <Linear Regulator (Configuration in Outline)>

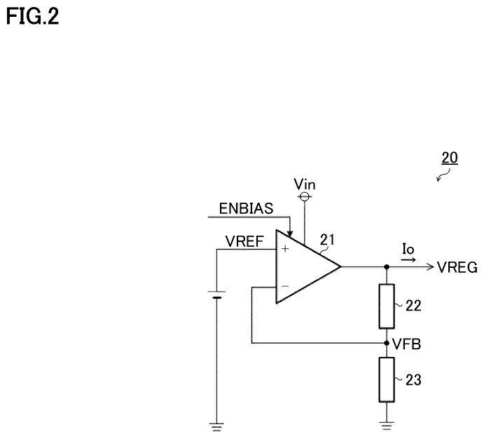

FIG. 2 is a diagram showing a schematic configuration of the linear regulator 20. The linear regulator 20 of this configuration example includes a stabilized voltage generation circuit 21 and resistors 22 and 23.

The stabilized voltage generation circuit 21 bucks the input voltage Vin to generate the stabilized voltage VREG by controlling an output stage, which is not shown in the diagram, so as to keep the reference voltage VREF, which is fed to the non-inverting input terminal (+) of the stabilized voltage generation circuit 21, equal to the feedback voltage VFB, which is fed to the inverting input terminal (−) of the stabilized voltage generation circuit 21. The stabilized voltage generation circuit 21 enables and disables bias current generation operation according to a bias enable signal ENBIAS.

The resistors 22 and 23 function as a feedback voltage generation circuit (i.e., a voltage division circuit) that outputs, from the connection node between them, the feedback voltage VFB according to the stabilized voltage VREG (i.e., a division voltage of the stabilized voltage VREG).

### Linear Regulator (First Embodiment)

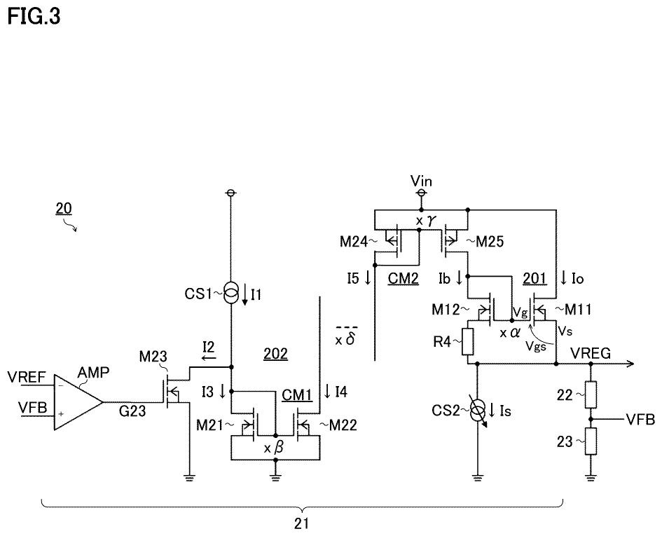

FIG. 3 is a diagram showing the linear regulator 20 according to a first embodiment (corresponding to a comparative example to be compared with the second embodiment described later). In the linear regulator 20 of this embodiment, the stabilized voltage generation circuit 21 includes, for example, transistors M11 and M12 (e.g., NMOSFETs), transistors M21 to M23 (e.g., NMOSFETs), transistors M24 and M25 (e.g., PMOSFETs), an operational amplifier AMP, current sources CS1 and CS2, and a resistor R4.

The drain of the transistor M11 is connected to the application terminal for the input voltage Vin. The gates of the transistors M11 and M12 are both connected to the drain of the transistor M12. The source of the transistor M12 is connected to the first terminal of the resistor R4. The drain of the transistor M11 and the second terminal of the resistor R4 are both connected to an application terminal for the stabilized voltage VREG.

So connected, the transistors M11 and M12 and the resistor R4 constitute a current mirror-type output stage 201 that generates an output current Io flowing in the transistor M11 by mirroring a bias current Ib flowing in the transistor M12 in a mirror ratio α (a mirror ratio α of 10 times or more).

The transistor M11 corresponds to a first transistor of an N-channel type configured to be connected between the application terminal for the input voltage Vin and the application terminal for the stabilized voltage VREG. The transistor M12 corresponds to a second transistor of an N-channel type configured to form the current mirror-type output stage 201 together with the transistor M11 so as to generate the output current Io flowing in the transistor M11 by mirroring the bias current Ib flowing in the transistor M12 itself.

The first terminal of the current source CS1 is connected to the power supply terminal. The second terminal of the current source CS1 is connected to the drains of the transistors M21 and M23. So connected, the current source CS1 functions as a first bias current generation circuit configured to generate a first bias current I1.

The gate of the transistor M23 is connected to the output terminal of the operational amplifier AMP (corresponding to an application terminal for a gate drive signal G23). The source of the transistor M23 is connected to the ground terminal. The operational amplifier AMP generates the gate drive signal G23 according to the reference voltage VREF, which is fed to its inverting input terminal (−), and the feedback voltage VFB, which is fed to its non-inverting input terminal (+).

So connected, the transistor M23 and the operational amplifier AMP function as a second bias current generation circuit configured to generate a second bias current I2 (corresponding to the drain current of the transistor M23) corresponding to the difference between the feedback voltage VFB and the reference voltage VREF. The second bias current I2 decreases when the feedback voltage VFB is lower than the reference voltage VREF and increases when the feedback voltage VFB is higher than the reference voltage VREF.

The gates of the transistors M21 and M22 are both connected to the drain of the transistor M21. The sources of the transistors M21 and M22 are both connected to the ground terminal. So connected, the transistors M21 and M22 function as a first current mirror CM1 configured to generate a fourth bias current I4 flowing in the transistor M22 by mirroring, in a mirror ratio β (where β≥1), a third bias current I3 (=I1−I2) that flows in the transistor M21 as the differential current resulting from subtracting the second bias current I2 from the first bias current I1.

The gates of the transistors M24 and M25 are both connected to the drain of the transistor M24. The sources of the transistors M24 and M25 are both connected to the application terminal for the input voltage Vin. The drain of the transistor M25 is connected to the drain of the transistor M12. So connected, the transistors M24 and M25 function as a second current mirror CM2 configured to generate a bias current Ib flowing in the transistor M25 by mirroring a fifth bias current I5 flowing in the transistor M24 in a mirror ratio γ (where γ≥1).

If an unshown current mirror is inserted between the drains of the transistors M22 and M24, the fifth bias current I5 is δ times the fourth bias current I4 (where δ≥1). In that case, the bias current Ib flowing in the transistor M12 is given by (I1−I2)×β×γ×δ.

The first bias current I1 has a fixed value and the second bias current I2 has a variable value. Thus, the bias current Ib decreases as the second bias current I2 increases, and increases as the second bias current I2 decreases. In other worlds, the bias current Ib increases when the feedback voltage VFB is lower than the reference voltage VREF, and decreases when the feedback voltage VFB is higher than the reference voltage VREF. The bias current Ib has its maximum value Ibmax (=I1×β×γ×δ) when the second bias current I2 is zero.

Thus, the current source CS1, the transistors M21 and M25, and the operational amplifier AMP constitute a feedback control circuit 202 configured to control the bias current Ib according to the difference between the feedback voltage VFB corresponding to the stabilized voltage VREG and the predetermined reference voltage VREF.

The first terminal of the current source CS2 is connected to the application terminal for the stabilized voltage VREG. The second terminal of the current source CS2 is connected to the ground terminal. So connected, the current source CS2 functions as a sink current generation circuit configured to draw a predetermined sink current Is from the application terminal for the stabilized voltage VREG.

Note that, in a case where the transistor M11 in the output stage 201 is of an N-channel type, if the difference between the input voltage Vin and the stabilized voltage VREG is small, a sufficient gate-source voltage Vgs (=Vg−Vs) for the transistor M11 cannot be obtained and the transistor M11 cannot be kept on. Thus, the undervoltage limit voltage of the semiconductor device 10 (corresponding to the low-input protection threshold of the low-input protection circuit 1A) cannot be set low.

To lower the undervoltage limit voltage of the semiconductor device 10, an element with a low on-threshold voltage Vth (what is called a low-Vth element) can be used as the transistor M11. However, low-Vth elements generally have a high output leakage current at high temperatures (i.e., a leakage component of the output current Io that leaks by flowing even when transistor M11 is fully off). Thus, when a low-Vth element is used as the transistor M11, it is preferable to take measures to suppress the output leakage current at high temperatures.

With a configuration that uses a current source CS2 to draw the sink current Is from the application terminal for the stabilized voltage VREG, an increase in the stabilized voltage VREG can be suppressed even if the output leakage current of the transistor M11 increases at high temperatures. However, this configuration does not suppress the output leakage current itself and with it the increase in circuit current Ic consumed by the linear regulator 20 cannot be eliminated.

Out of the consideration above, a second embodiment will be presented below that can suppress an output leakage current at high temperatures.

### Linear Regulator (Second Embodiment)

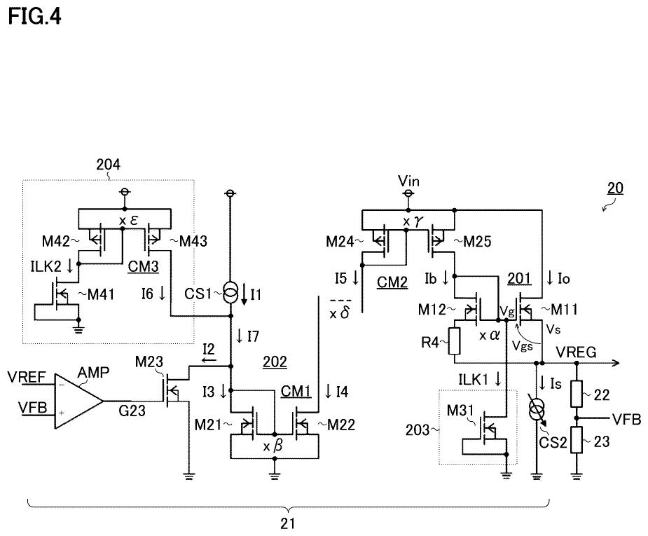

FIG. 4 is a diagram showing the linear regulator 20 according to a second embodiment. In the linear regulator 20 of this embodiment, the stabilized voltage generation circuit 21 includes, in addition to the components described previously, a load 203 and a bias current adjuster 204.

The load 203 is configured to draw a first leakage current ILK1 from a gate common to (i.e., the gates connected together of) the transistors M11 and M12. As shown in the diagram, the load 203 includes a transistor M31 (e.g., an NMOSFET).

The drain of the transistor M31 is connected to the gates of the transistors M11 and M12. The source and the gate of the transistor M31 are both connected to the ground terminal. Thus, the transistor M31 is always in a fully off state. The transistor M31 corresponds to a third transistor of an N-channel type configured to have the same leakage current characteristics as the transistor M11.

With this configuration, as the first leakage current ILK1 flowing in the transistor M31 increases at high temperature, the gate-source voltage Vgs of the transistor M11 becomes negative (i.e., the gate voltage Vg of the transistor M11 becomes lower than the source voltage Vs). Thus, the on-resistance of the transistor M11 is raised, and this suppresses an increase in the output leakage current flowing in transistor M11 and eliminates an increase in the circuit current Ic of the linear regulator 20.

In particular, in a light-load condition, the output current Io flowing in the transistor M11 is reduced and thus the proportion of the output leakage current in the circuit current Ic of the linear regulator 20 increases. Thus, by introducing the load 203 to suppress an increase in the output leakage current, it is possible to increase the efficiency at high temperature in a light-load condition.

The bias current adjustment circuit 204 is configured to increase the bias current Tb by at least the same level as the first leakage current ILK1 when the transistor M11 is turned on.

As shown in the diagram, the bias current adjustment section 204 includes a transistor M41 (e.g., an NMOSFET) and transistors M42 and M43 (e.g., PMOSFETs).

The drain of the transistor M41 is connected to the drain of the transistor M42. The source and the gate of the transistor M41 are both connected to the ground terminal. Thus, the transistor M41 is always in the fully off state. The transistor M41 corresponds to a fourth transistor of an N-channel type configured to have the same leakage current characteristics as the transistor M31 (and hence the transistor M11).

The gates of the transistors M42 and M43 are both connected to the drain of the transistor M42. The sources of the transistors M42 and M43 are both connected to the power supply terminal. The drain of the transistor M43 is connected to the drains of the transistors M21 and M23. So connected, the transistors M42 and M43 function as a third current mirror CM3 configured to generate a mirror current I6 flowing in transistor M43 by mirroring a second leakage current ILK2 flowing in the transistor M42 in a mirror ratio ε. The mirror ratio ε depends on the device sizes of the transistors M31 and M41. When the device sizes of the transistors M31 and M41 are the same, ε≥1/(β×γ×δ). The mirror ratio ε needs to be set sufficiently high to accommodate variations in the transistors M31 and M41 and variations in the third current mirror CM3.

With the bias current adjustment circuit 204 introduced, the third bias current I3 flowing in the transistor M21 in the first current mirror CM1 is a differential current (=I1−2+ILK2×ε) resulting from subtracting the second bias current I2 from the sum current I7 (=I1+I6) of the mirror current I6 (=ILK2×F) of the second leakage current ILK2 and the first bias current I1.

Thus, for example, when the feedback voltage VFB is lower than the reference voltage VREF and the transistor M23 is in a fully off state (I2=0), the maximum value Ib max of the bias current Ib is (I1+ILK2×ε)×β×γ×δ. Thus, with the bias current adjustment circuit 204 introduced, the maximum value Ib max of the bias current Ib is increased by ILK2×β×γ×δ×ε (≥ILK1), that is, an extra amount corresponding to the second leakage current ILK2.

According to this configuration, when the first leakage current ILK1 increases at high temperature, the second leakage current ILK2 also increases with the same behavior, thus increasing the maximum value Ib max of the bias current Ib. This makes it possible to prevent, with the requisite minimum mirror current I6, the first leakage current ILK1 from becoming higher than the maximum value Ib max of the bias current Ib due to device variations and the like. Thus, an advantage is obtained in that, at temperatures at which the first leakage current ILK1 is low, no unnecessary current flows.

Thus, for example, even if the first bias current I1 is set to a very low current value to reduce the circuit current Ic of the linear regulator 20, the bias current Ib required to turn on the transistor M11 does not become insufficient. Thus, the on transition of the transistor M11 is not hampered and the output current supply capacity of linear regulator 20 is not impaired.

On the other hand, when the feedback voltage VFB becomes higher than the reference voltage VREF, the transistor M23 is in the fully off state and all the mirror current I6 corresponding to the second leakage current ILK2 is drawn by the transistor M23. Thus, the negative bias operation of the above-mentioned gate-source voltage Vgs by the first leakage current ILK1 is not impaired.

### <The Temperature Characteristics>

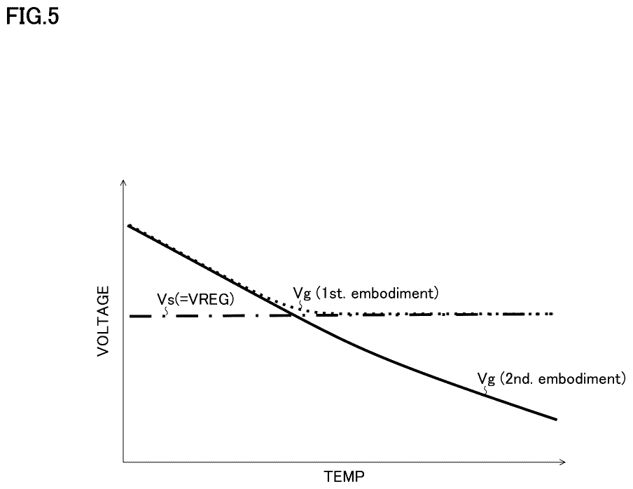

FIG. 5 is a diagram showing the temperature characteristics of the source voltage Vs (i.e., the stabilized voltage VREG) and the gate voltage Vg of the transistor M11. The horizontal axis in the diagram represents temperature and the vertical axis in the diagram represents voltage. With respect to the gate voltage Vg, the solid line indicates the behavior in the second embodiment (FIG. 4) and the broken line indicates the behavior in the first embodiment (FIG. 3).

As shown in the diagram, in the first embodiment (broken line), as temperature rises, the gate voltage Vg of the transistor M11 falls only down to the source voltage Vs. On the other hand, in the second embodiment (solid line), as temperature rises, the gate voltage Vg of the transistor M11 falls below the source voltage Vs. Thus, at high temperature, the gate-source voltage Vgs (=V−Vs) of the transistor M11 becomes negative. Thus, the on-resistance of the transistor M11 is raised, which suppresses an increase in the output leakage current flowing in the transistor M11 and eliminates an increase in the circuit current Ic of the linear regulator 20.

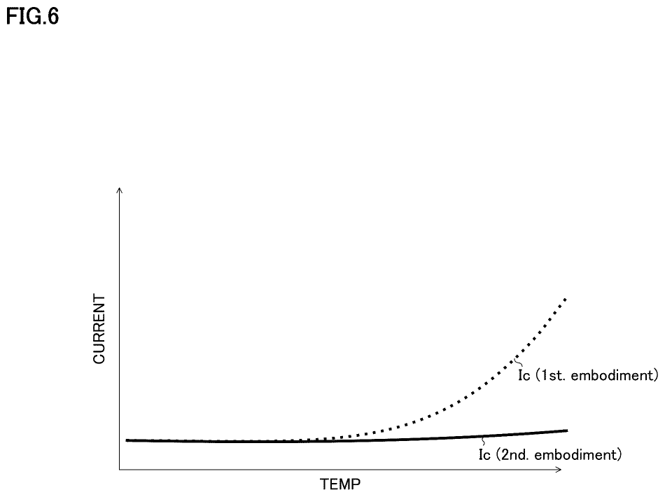

FIG. 6 is a diagram showing the temperature characteristics of the circuit current Ic of the linear regulator 20. The horizontal axis in the diagram represents temperature and the vertical axis in the diagram represents current. The solid line indicates the behavior in the second embodiment (FIG. 4) and the broken line represents the behavior in the first embodiment (FIG. 3).

As shown in the diagram, the second embodiment (solid line) can reduce the circuit current Ic of the linear regulator 20 at high temperatures compared to the first embodiment (broken line).

### <Overview>

The following is an overview of the various embodiments described above.

According to one aspect of what is disclosed herein, a linear regulator includes: a first transistor of an N-channel type configured to be connected between an application terminal for an input terminal and an application terminal for a stabilized voltage; a second transistor of an N-channel type configured to, by forming a current mirror type output stage with the first transistor, generate an output current flowing in the first transistor by mirroring a bias current flowing in the second transistor itself; a feedback controller configured to control the bias current according to the difference between a feedback voltage corresponding to the stabilized voltage and a predetermined reference voltage; and a load configured to draw a first leakage current from a control terminal common to the first and second transistors. (A first configuration.)

In the linear regulator of the first configuration described above, the load can include a third transistor of an N-channel type configured to have the same leakage current characteristics as the first transistor. (A second configuration.)

The linear regulator of the first or second configuration described above can further include a bias current adjuster configured to increase the bias current by at least the same amount as the first leakage current when the first transistor is turned on. (A third configuration.)

In the linear regulator of the third configuration described, the bias current adjuster can include a fourth transistor of an N-channel type configured to have the same leakage current characteristics as the load. (A fourth configuration.)

In the linear regulator of any of the first to third configurations described above, the feedback control circuit can include a first bias current generation circuit configured to generate a predetermined first bias current, a second bias current generation circuit configured to generate a second bias current corresponding to the difference between the feedback voltage and the reference voltage, and a current mirror configured to generate the bias current by mirroring the difference current obtained by subtracting the second bias current from the first bias current, (A fifth configuration.)

In the linear regulator of the fourth configuration above, the feedback control circuit can include: a first bias current generation circuit configured to generate a predetermined first bias current; a second bias current generation circuit configured to generate a second bias current corresponding to the difference between the feedback voltage and the reference voltage; and a current mirror configured to generate the bias current by mirroring the difference current obtained by subtracting the second bias current from the sum current of a second leakage current flowing in the fourth transistor or a mirror current of it and the first bias current. (A sixth configuration).

The linear regulator of any of the first to sixth configurations described above can further include a sink current generation circuit configured to draw a predetermined sink current from the application terminal for the stabilized voltage. (A seventh configuration.)

In the linear regulator of any of the first to seventh configurations described above, the output stage can have a mirror ratio of 10 or more. (An eighth configuration.)

For example, according to another aspect of what is disclosed herein, a semiconductor device includes the linear regulator of any one of the first to eighth configurations described above. (A ninth configuration.)

For example, according to yet another aspect of what is disclosed herein, a switching power supply includes the semiconductor device of the ninth configuration described above and is configured to drive a switching output stage to generate the desired output voltage from the input voltage. (A tenth configuration).

According to the present disclosure, it is possible to provide a linear regulator, a semiconductor device, and a switching power supply capable of suppressing an output leakage current at high temperature.

### <Other Modifications>

The various technical features disclosed herein can be implemented with any modifications made to the extent not to depart from the spirit of their technical ingenuity. In other words, the above embodiments should be considered merely illustrative and not restrictive in every aspect, and the technical scope of the present disclosure should be understood to be defined by the appended claims and encompasses any modifications that fall within the scope equivalent in significance to the claims.

1. A linear regulator comprising:
a first transistor of an N-channel type configured to be connected between an application terminal for an input terminal and an application terminal for a stabilized voltage;
a second transistor of an N-channel type configured to, by forming a current mirror type output stage with the first transistor, generate an output current flowing in the first transistor by mirroring a bias current flowing in the second transistor itself;
a feedback controller configured to control the bias current according to a difference between a feedback voltage corresponding to the stabilized voltage and a predetermined reference voltage; and
a load configured to draw a first leakage current from a control terminal common to the first and second transistors.

2. The linear regulator according to claim 1, wherein the load includes a third transistor of an N-channel type configured to have same leakage current characteristics as the first transistor.

3. The linear regulator according to claim 1, further comprising a bias current adjuster configured to increase the bias current by at least a same amount as the first leakage current when the first transistor is turned on.

4. The linear regulator according to claim 3, wherein the bias current adjuster includes a fourth transistor of an N-channel type configured to have same leakage current characteristics as the load.

5. The linear regulator according to claim 1, wherein the feedback controller includes:
a first bias current generation circuit configured to generate a predetermined first bias current;
a second bias current generation circuit configured to generate a second bias current corresponding to the difference between the feedback voltage and the reference voltage; and
a current mirror configured to generate the bias current by mirroring a differential current obtained by subtracting the second bias current from the first bias current.

6. The linear regulator according to claim 4, wherein the feedback controller includes:
a first bias current generation circuit configured to generate a predetermined first bias current;
a second bias current generation circuit configured to generate a second bias current corresponding to the difference between the feedback voltage and the reference voltage;
a current mirror configured to generate the bias current by mirroring a differential current obtained by subtracting the second bias current from a sum current of a second leakage current flowing in the fourth transistor or a mirror current thereof and the first bias current.

7. The linear regulator according to claim 1, further comprising a sink current generation circuit configured to draw a predetermined sink current from the application terminal for the stabilized voltage.

8. The linear regulator according to claim 1, wherein the output stage has a mirror ratio of 10 or more.

9. A semiconductor device comprising the linear regulator according to claim 1.

10. A switching power supply comprising the semiconductor device according to claim 9, wherein the switching power supply drives a switching output stage to generate a desired output voltage from the input voltage.
